(19) United States
(12) Patent Application Publication
(10) Pub. No.: US 2012/0034427 A1
(43) Pub. Date: Feb. 9, 2012

(54) Chopping Board Structure With Replaceable Chopping Surface

(76) Inventor: Cheng-Che Hsieh, Yongkang City (TW)

(21) Appl. No.: 12/850,906

(22) Filed: Aug. 5, 2010

(51) Int. Cl. B32B 5/00

(52) U.S. Cl. 428/172

(57) ABSTRACT

A chopping board structure with a replaceable chopping surface includes a board base, an upper non-slip pad, a lower non-slip pad, and a replaceable chopping board. The board base is a concave board and has a geometric concave recess at one side thereof to receive the upper non-slip pad and the chopping board. At least one side of the geometric concave recess is formed with a notch. Another side of the board base is a flat surface attached to the lower non-slip pad. The upper and lower non-slip pads have a shape corresponding to the board base or the geometric concave recess. One side of the upper and lower non-slip pads has a non-slip layer. The chopping board has a shape corresponding to board base or the geometric concave recess and is placed on the upper non-slip pad. The upper and lower non-slip pads are respectively attached to the geometric concave recess and the bottom of the board base. The chopping board is placed on the upper non-slip pad which provides a non-slip effect. When replacing the chopping board, the user can take away the chopping board with his/her finger extending into the notch and then place a desired chopping board in the geometric concave recess. The present invention provides a replaceable chopping board to classify the food and enhances the non-slip effect.

### BACKGROUND OF THE INVENTION

1. Field of the Invention

The present invention relates to a chopping board structure with a replaceable chopping surface, and more particularly to an upper non-slip pad and a lower non-slip pad attached to two sides of a board base an a replaceable chopping board placed on the upper non-slip pad. The chopping board structure provides a replaceable chopping board to classify the food and enhances the non-slip effect.

2. Description of the Prior Art

As shown in FIG. 10, a conventional plastic chopping board comprises a board base 51 and a chopping board 52 to be an integral one piece. The chopping board 52 is treated with anti-microbial treatment for use. However, the number of the chopping boards is limited to two. This is inconvenient to classify the food. Sometimes, the user has to purchase another one for classification.

### SUMMARY OF THE INVENTION

The primary objective of the present invention is to provide a chopping board structure with a replaceable chopping surface. The chopping board structure comprises a board base which a flat or concave board. The flat board has two flat surfaces to couple with an upper non-slip pad and a lower non-slip pad, respectively. The concave board has a concave recess in a geometric shape to receive the upper non-slip pad and a chopping board therein. At least one side of the concave recess is formed with a notch. The notch has a bottom which is flush with the upper non-slip pad for the chopping board to be taken away with ease. Another side of the concave board is flat surface to couple with the lower non-slip pad. The upper and lower non-slip pads have a shape corresponding to the board base or the concave recess.

One side of the upper non-slip pad has a non-slip layer attached to the chopping board, and another side of the upper non-slip pad is a flat surface attached to the concave recess. One side of the lower non-slip pad has a non-slip layer placed on a platform, and another side of the lower non-slip pad is a flat surface attached to the board base. The chopping board is replaceable and made in any color. The chopping board has a shape corresponding to the board base or the concave recess. One side of the chopping board is placed on the upper non-slip pad. The chopping board has a pattern hole thereon. The pattern hole is a sign, a figure or a trademark for identifying or marking the chopping board. The chopping board may have a non-slip layer to enhance the non-slip effect relative to the non-slip pad. When the chopping board is replaced, the user can take away the chopping board with his/her finger extending into the notch and then place a desired chopping board on the upper non-slip pad in the concave recess. The present invention provides a replaceable chopping board to classify the food and enhances the non-slip effect.

A further objective of the present invention is to provide a chopping board structure with a replaceable chopping surface. The upper and lower non-slip pads correspond in shape to the board base and attach to the upper and lower sides of the board base. The chopping board also corresponds in shape to the board base, and is placed on the upper non-slip pad. A non-slip layer is provided on the concave recess. The non-slip layer provides a non-slip effect to the chopping board. When replacing the chopping board, the chopping board can be taken away directly and then be replaced with a desired chopping board on the upper non-slip pad, providing the same effect as the aforesaid.

A further objective of the present invention is to provide a chopping board structure with a replaceable chopping surface. The chopping board is made in any color and has a pattern hole thereon. The pattern hole is a sign, a figure or a trademark for identifying or marking the chopping board. Another side of the chopping board is provided with a non-slip layer placed on the upper non-slip pad to enhance the non-slip effect. After the food is chopped on the chopping board, the user takes out the chopping board with his/her finger extending into the notch. The chopping board can be folded into a desired shape to put the food into the pot for cooking. The chopping board of the present invention provides clear, non-slip and replaceable effects.

### BRIEF DESCRIPTION OF THE DRAWINGS

FIG. 1 is a perspective view according to a first embodiment of the present invention;

FIG. 2 is an exploded view according to the first embodiment of the present invention;

FIG. 3 is a cross-sectional view according to the first embodiment of the present invention;

FIG. 4-A and FIG. 4-B are perspective views showing a chopping board of the present invention;

FIG. 5 is a perspective view according to a second embodiment of the present invention;

FIG. 6 is an exploded view according to the second embodiment of the present invention;

FIG. 7-A and FIG. 7-B are perspective views showing a chopping board of the present invention;

FIG. 8 is a perspective view according to a third embodiment of the present invention;

FIG. 9 is a schematic view showing the chopping board in a folded state, and

FIG. 10 is a perspective view of a conventional chopping board.

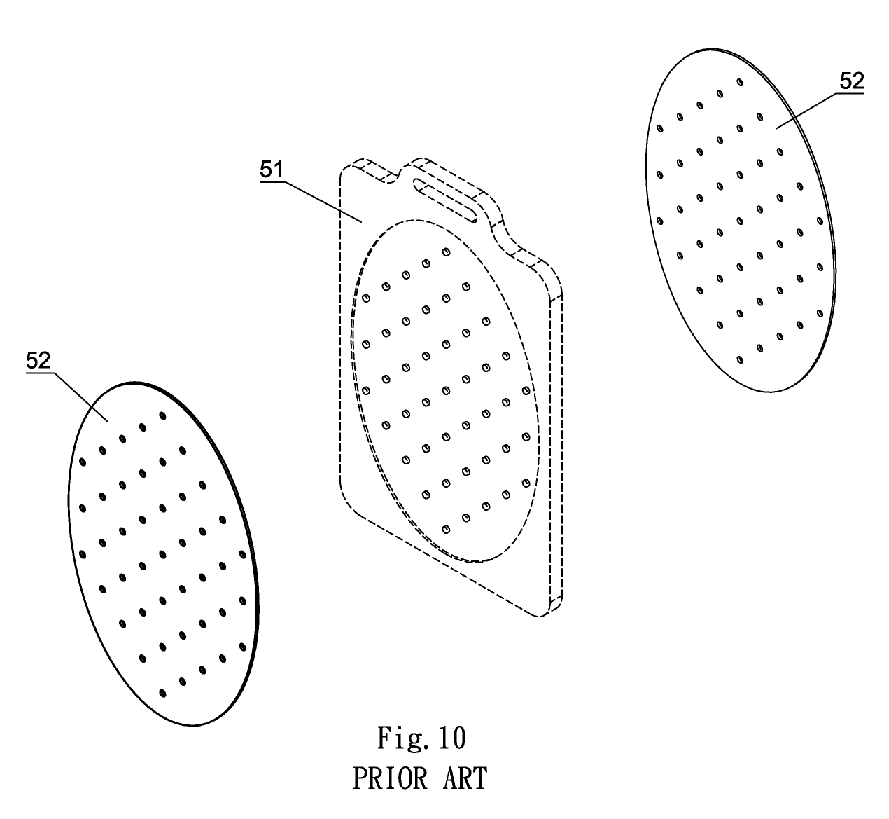

### DETAILED DESCRIPTION OF THE PREFERRED EMBODIMENTS

Embodiments of the present invention will now be described, by way of example only, with reference to the accompanying drawings.

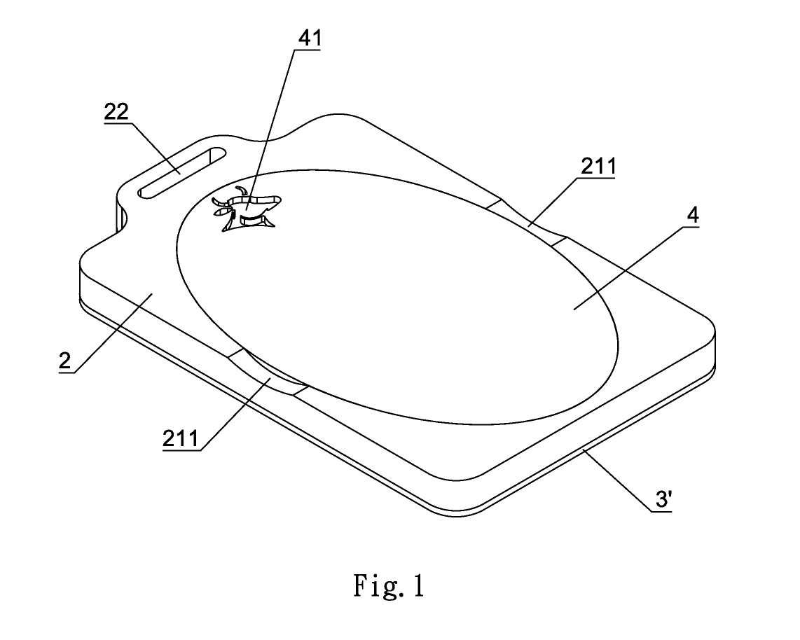

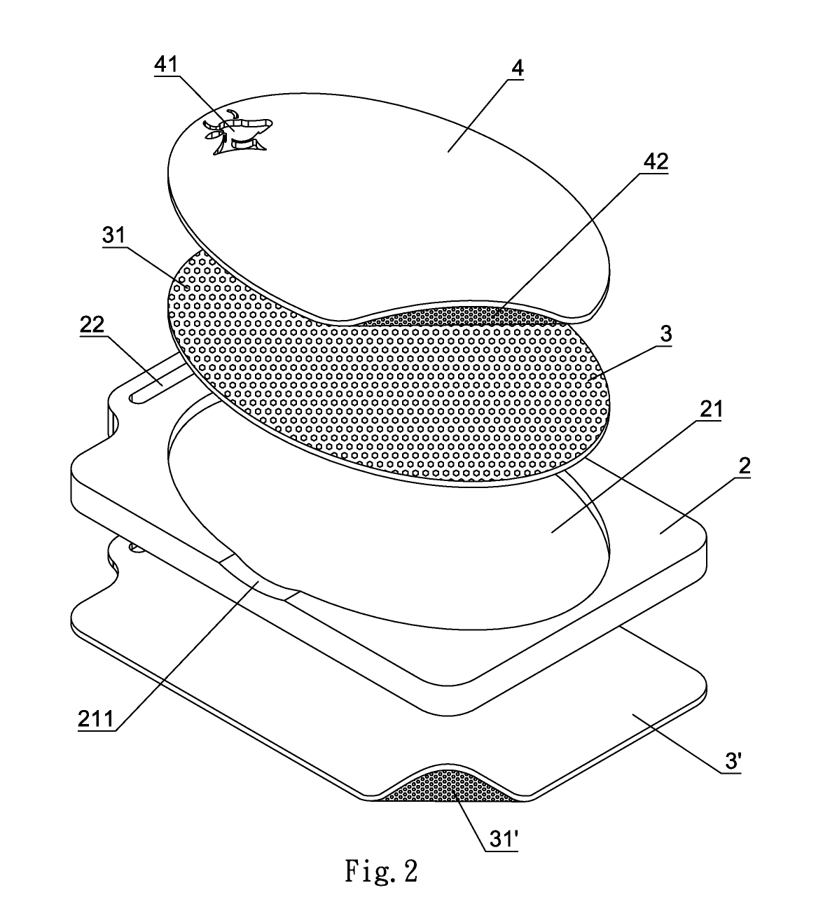

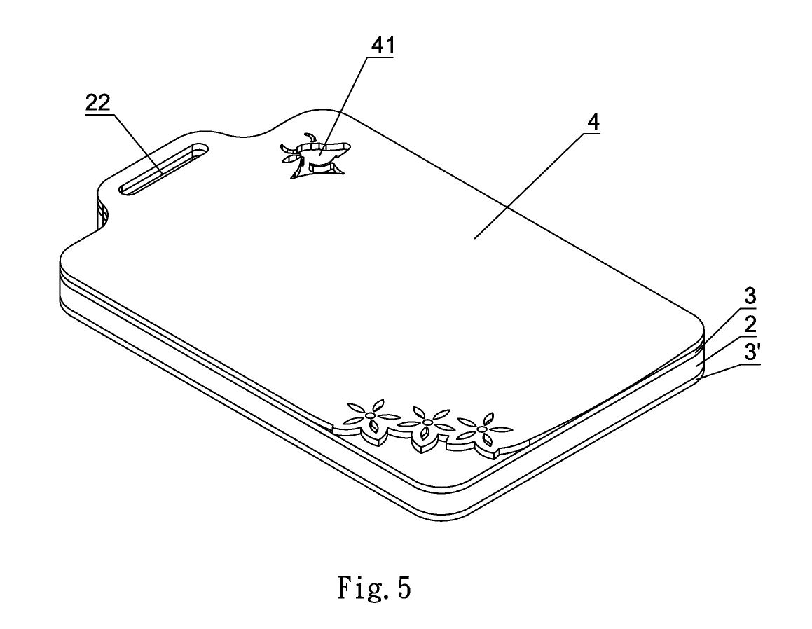

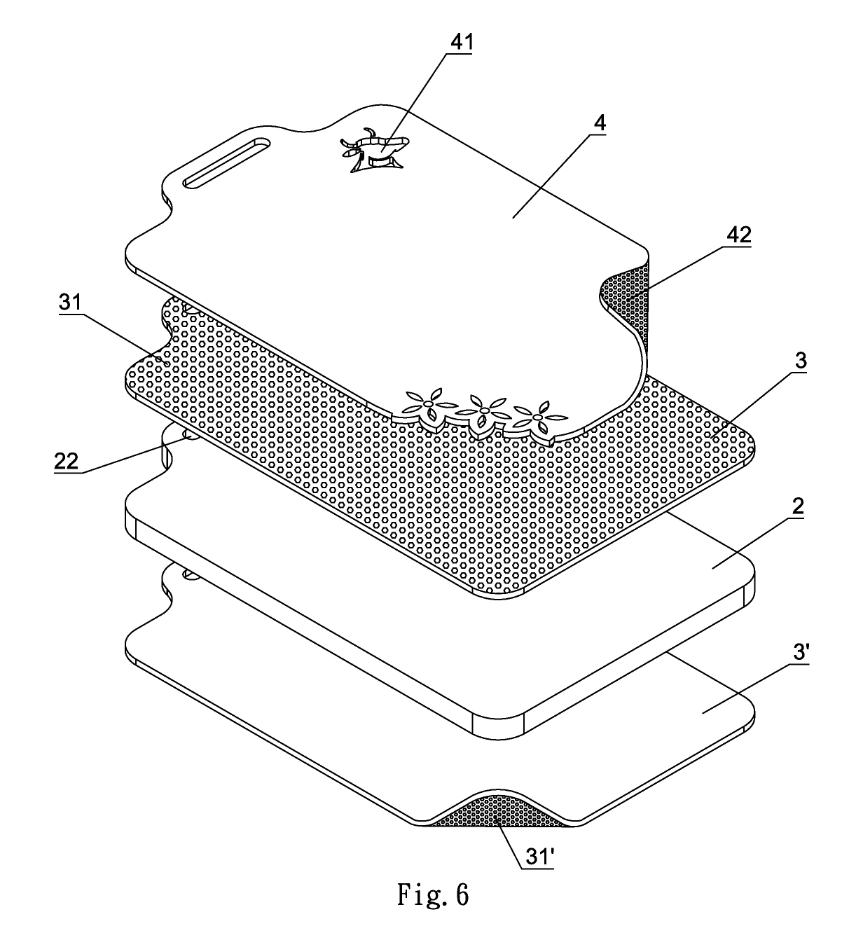

As show in FIG. 1, FIG. 2, FIG. 5, and FIG. 6, the present invention comprises a board base 2 which can be a flat board or a concave board. One end of the board base 2 is provided with handle 22 for the user to carry. The flat board has two flat surfaces to couple with an upper non-slip pad 3 and a lower non-slip pad 3′, respectively. The concave board has a concave recess 21 in a geometric shape to receive the upper non-slip pad 3 and a chopping board 4 therein. Alternatively, a non-slip layer 212 is provided on the concave recess 21 to couple with the chopping board 4. The concave recess 21 may have a square or oval shape. At least one side of the concave recess 21 is formed with a notch 211. The notch 211 has a bottom which is flush with the upper non-slip pad 3 for the chopping board 4 to be taken away with ease. Another side of the concave board is flat surface to couple with the lower non-slip pad 3′.

The upper and lower non-slip pads 3, 3′ are formed by extrusion, pressing or injection and have a shape corresponding to the board base 2 or the concave recess 21. One side of the upper non-slip pad 3 has a non-slip layer 31 attached to the chopping board 4, and another side of the upper non-slip pad 3 is a flat surface attached to the concave recess 21. One side of the lower non-slip pad 3′ has a non-slip layer 31′ placed on a platform, and another side of the lower non-slip pad 3′ is a flat surface attached to the board base 2.

The chopping board 4 is replaceable and non-slip. The chopping board 4 is formed by extrusion, pressing or injection and has a shape corresponding to the board base 2 or the concave recess 21. One side of the chopping board 4 is placed on the upper non-slip pad 3. The chopping board 4 is treated with anti-microbial treatment to prevent bacteria. The chopping board 4 has a pattern hole 41 thereon. The pattern hole 41 is a sign, a figure or a trademark for identifying or marking the chopping board. The chopping board 4 may have a non-slip layer 42 to enhance the non-slip effect relative to the non-slip pad 3. The present invention provides a replaceable chopping board to classify the food.

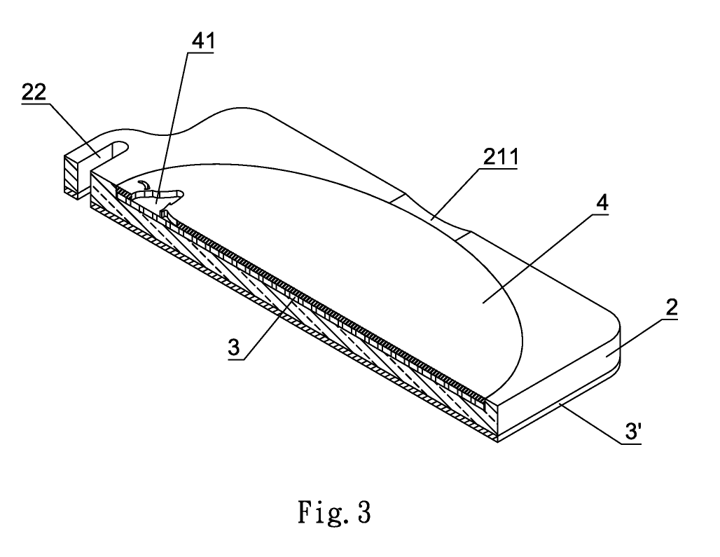

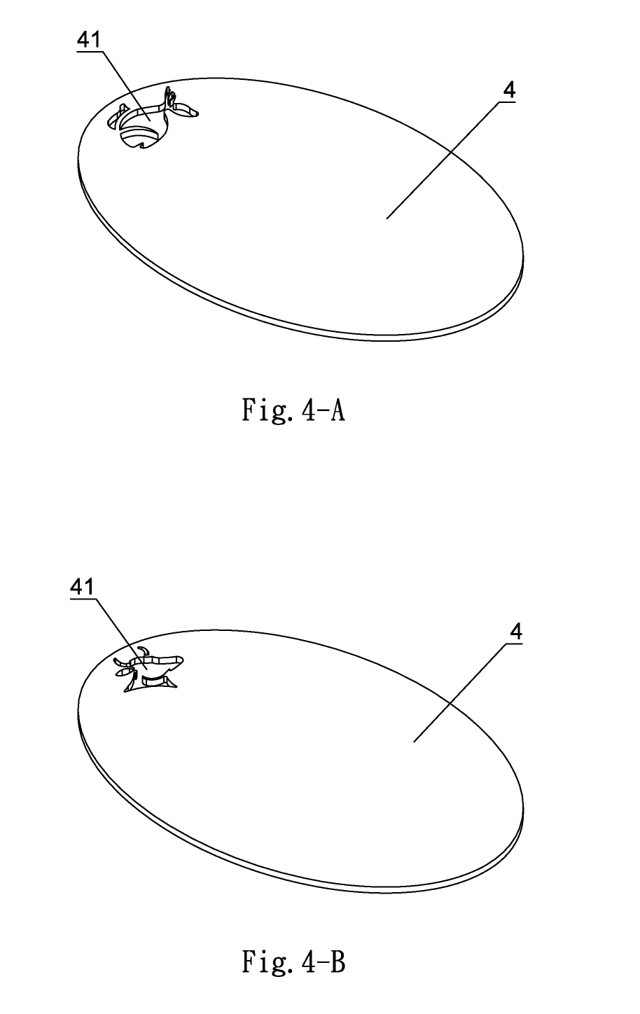

FIG. 1 to FIG. 3, FIG. 4-A and FIG. 4-B show a first embodiment of the present invention. The upper side of the board base 2 is formed with the concave recess 21 which has an oval shape. The upper non-slip pad 3 has the same oval shape to be received in the concave recess 21. The lower non-slip pad 3′ corresponds in shape to the board base 2. The upper side of the lower non-slip pad 3′ is attached to the board base 2, and the lower side of the lower non-slip pad 3′ is placed on a platform. The replaceable chopping board 4 has the same oval shape corresponding to the concave recess 21, and is placed on the upper non-slip pad 3 which can prevent the chopping board 4 from movement, as shown in FIG. 2 and FIG. 3. When the chopping board 4 is replaced, the user can take away the chopping board 4 with his/her finger extending into the notch 211 and then place a desired chopping board 4 on the upper non-slip pad 3 in the concave recess 21. The present invention provides a replaceable chopping board 4 to classify the food and enhances the non-slip effect.

FIG. 5 and FIG. 6 show a second embodiment of the present invention. The upper and lower non-slip pads 3, 3′ correspond in shape to the board base 2 and attach to the upper and lower sides of the board base 2. The chopping board 4 also corresponds in shape to the board base 2, and is placed on the upper non-slip pad 3. The non-slip layer 31 provides a non-slip effect to the chopping board 4, as shown in

FIG. 6. When replacing the chopping board 4, the chopping board 4 can be taken away directly and then be replaced with a desired chopping board 4 on the upper non-slip pad 3, providing the same effect as the aforesaid.

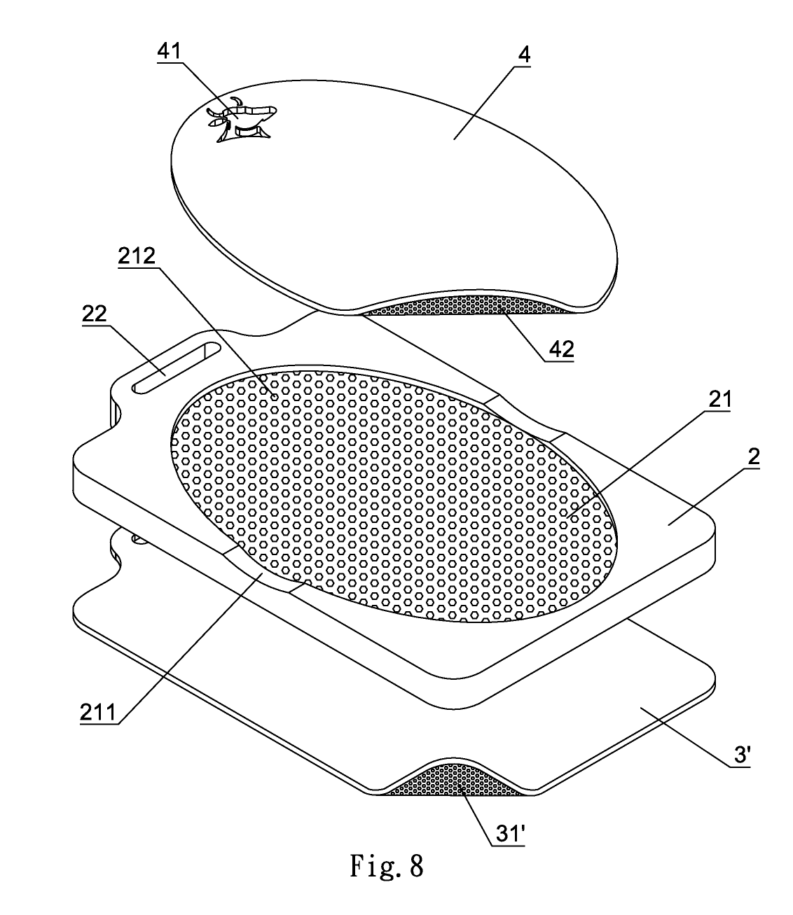

FIG. 8 shows a third embodiment of the present invention. The non-slip layer 212 is disposed on the concave recess 21 of the board base 2. The chopping board 4 in an oval shape is placed on the concave recess 21 which provides a non-slip effect. When replacing the chopping board 4, the chopping board 4 can be taken away directly and then be replaced with a desired chopping board 4 on the non-slip layer 212, providing the same effect as the aforesaid.

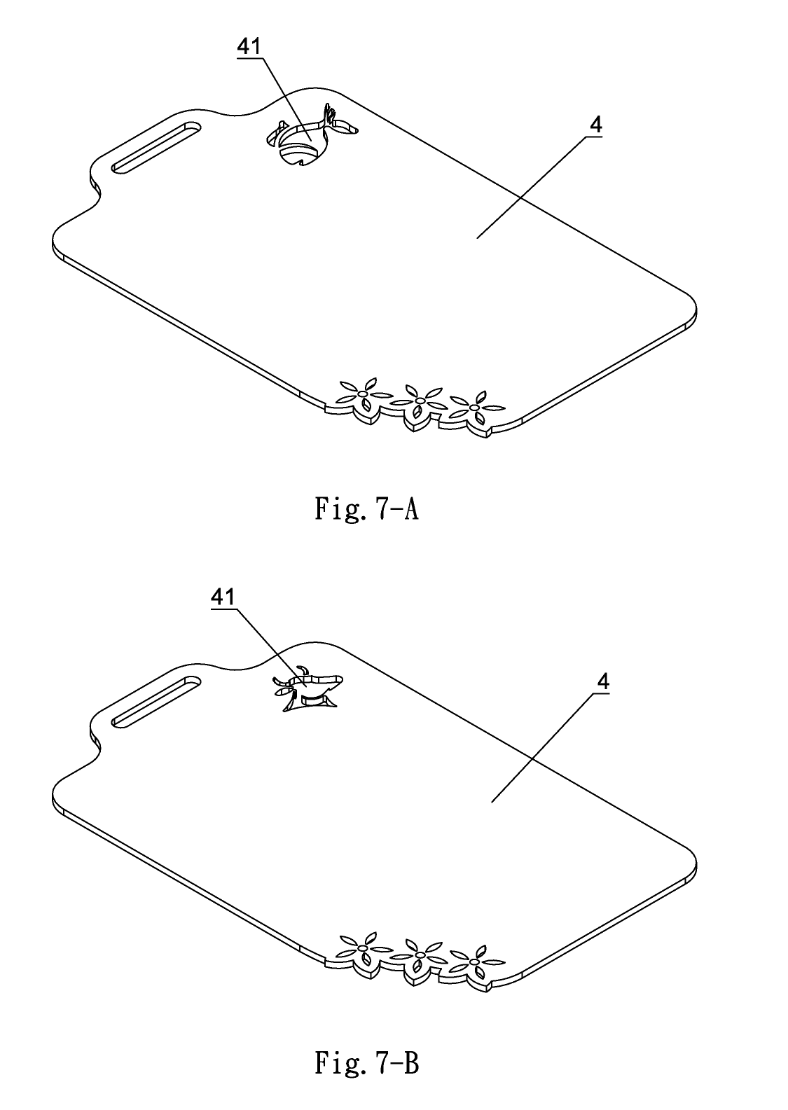

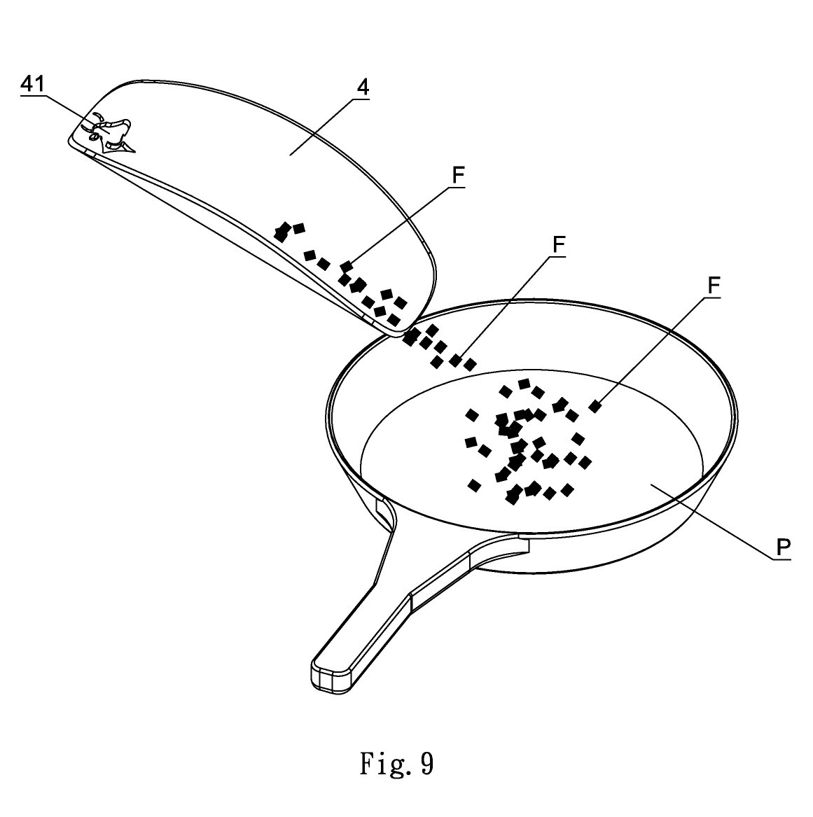

Referring to FIG. 2, FIG. 4-A, FIG. 4-B, FIG. 6, FIG. 7-A, FIG. 7-B and FIG. 9, the chopping board 4 is in a single color, and the pattern hole 41 is in a fish or cow shape for the user to know and identify respective chopping boards with ease. The non-slip layer 42 placed on the upper non-slip pad 3 enhances the non-slip effect. After the food is chopped on the chopping board 4, the user takes out the chopping board 4 with his/her finger extending into the notch 211. The chopping board 4 can be folded into a desired shape to put the food F into the pot P for cooking, as shown in FIG. 9. The chopping board 4 of the present invention provides clear, non-slip and replaceable effects.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A chopping board structure with a replaceable chopping surface, comprising:
a board base, the board base having a geometric concave recess at one side thereof, at least one side of the geometric concave recess being formed with a notch, the notch having a bottom which is flush with an upper non-slip pad;
the upper non-slip pad and a lower non-slip pad, the upper and lower non-slip pads being formed by extrusion, pressing or injection and having a shape corresponding to the board base or the geometric concave recess, one side of the upper non-slip pad having a non-slip layer and another side of the upper non-slip pad being a flat surface attached to the geometric concave recess, one side of the lower non-slip pad having a non-slip layer and another side of the lower non-slip pad being a flat surface attached to the board base; and
a chopping board, the chopping board being replaceable and formed by extrusion, pressing or injection and having a shape corresponding to the geometric concave recess, one side of the chopping board being a flat surface placed on the upper non-slip pad, the chopping board having a pattern hole thereon;
thereby, the upper and lower non-slip pads being attached to the board base respectively, the chopping board being placed on the upper non-slip pad to confine movement of the chopping board.

2. A chopping board structure with a replaceable chopping surface, comprising:
a board base, the board base having a geometric concave recess at one side thereof, a non-slip layer provided on the geometric concave recess, at least one side of the geometric concave recess being formed with a notch, the notch having a bottom which is flush with an upper non-slip pad;
a lower non-slip pad, the lower non-slip pad being formed by extrusion, pressing or injection and having a shape corresponding to the board base, one side of the lower non-slip pad having a non-slip layer and another side of the lower non-slip pad being a flat surface attached to the board base; and
a chopping board, the chopping board being replaceable and formed by extrusion, pressing or injection and having a shape corresponding to the geometric concave recess, one side of the chopping board being a flat surface placed on the upper non-slip pad, the chopping board having a pattern hole thereon. thereby, the non-slip layer in the geometric concave recess and the lower non-slip pads being attached to the board base respectively, the chopping board being placed on the non-slip layer to confine movement of the chopping board.

3. The chopping board structure as claimed in claim 1, wherein the geometric concave recess has a square or oval shape.

4. A chopping board structure with a replaceable chopping surface, comprising:
a board base, the board base having two flat side surfaces attached to an upper non-slip pad and a lower non-slip pad;
the upper and lower non-slip pads being formed by extrusion, pressing or injection and having a shape corresponding to the board base, one side of the upper non-slip pad having a non-slip layer, one side of the lower non-slip pad having a non-slip layer; and
a chopping board, the chopping board being replaceable and formed by extrusion, pressing or injection and having a shape corresponding to the board base, one side of the chopping board being a flat surface placed on the upper non-slip pad, the chopping board having a pattern hole thereon.
thereby, the upper and lower non-slip pads being attached to the board base respectively, the chopping board being placed on the upper non-slip pad to confine movement of the chopping board.

5. The chopping board structure as claimed in claim 1, wherein one end of the board base is provided with a handle.

6. The chopping board structure as claimed in claim 1, wherein the pattern hole is a sign, a figure or a trademark.

7. The chopping board structure as claimed in claim 1, wherein one side of the upper non-slip pad is provided with a non-slip layer.

8. The chopping board structure as claimed in claim 2, wherein one end of the board base is provided with a handle.

9. The chopping board structure as claimed in claim 2, wherein one end of the board base is provided with a handle.

10. The chopping board structure as claimed in claim 2, wherein one end of the board base is provided with a handle.

11. The chopping board structure as claimed in claim 4, wherein one end of the board base is provided with a handle.

12. The chopping board structure as claimed in claim 4, wherein one end of the board base is provided with a handle.

13. The chopping board structure as claimed in claim 4, wherein one end of the board base is provided with a handle.

14. The chopping board structure as claimed in claim 2, wherein the geometric concave recess has a square or oval shape.
